(19) United States
(12) Patent Application Publication
(10) Pub. No.: US 2012/0179491 A1
(43) Pub. Date: Jul. 12, 2012

(54) HIGH PERFORMANCE AND INTEGRATED NOSOCOMIAL INFECTION SURVEILLANCE AND EARLY DETECTION SYSTEM AND METHOD THEREOF

(75) Inventors: CHIEN-TSAI LIU, Taipei City (TW); YU-SHENG LO, Taipei City (TW)

(73) Assignee: TAIPEI MEDICAL UNIVERSITY, Taipei City (TW)

(21) Appl. No.: 13/344,992

(22) Filed: Jan. 6, 2012

(30) Foreign Application Priority Data
Jan. 7, 2011 (TW) 100100746

(51) Int. Cl. G06Q 50/22; G06Q 50/24

(52) U.S. Cl. 705/3; 705/2

(57) ABSTRACT

A high performance and integrated nosocomial infection control surveillance and detection system includes a patient database having a patient information, a clinical database having a patient clinical information, a nosocomial infection surveillance model with capability to detect suspected cases, an infection monitoring dashboard presenting an integrated view of a patient information and infection conditions in the clinical database for each patient. The patient database, clinical database, nosocomial infection surveillance model and the infection monitoring dashboard are built in different network servers or a network server to meet the optimum efficiency for a user to conduct infection control and early detection of infected cases through his/her account.

### FIELD OF THE INVENTION

The present invention is directed to a healthcare quality system. In particular, the present invention is directed to a high performance and integrated healthcare and nosocomial infection surveillance system running via the internet and method thereof.

### BACKGROUND OF THE INVENTION

Nosocomial infections are infections that patients acquire during being hospitalized and common complications among patients in the hospital. Nosocomial infections will worsen conditions and mentalities of patients, even cause death; they also increase the workload of the medical personnel and the possibility of being infected; for a hospital, besides the increase of the medical resource consumption and decrease of the turnover rate of the hospital beds, they may raise medical disputes.

Therefore, an efficient nosocomial infection surveillance is one of the first priority regarding medical quality and safety of patients. The nosocomial infection surveillance focuses on collecting and analyzing the nosocomial infection information and regularly tracing the results, which means to carry out systematic, positive, proactive and ongoing surveillances of the occurrence and distribution of nosocomial infections, investigate the cause of nosocomial infections, and search for dangerous factors, pathogenic bacteria and drug resistance thereof.

For the time being, the nosocomial infection surveillance is on the basis of bacteria results. The daily or periodical and positive bacteria results detected by the designed infection surveillance system are provided as references for the monitoring personnel (Bouam S, Brossette S E, Chalfine A)[1-3].

In addition, Spolaore, Pokorny, Leth et al. [4-6] consider that the infection surveillance system should combine the positive bacteria results with other information so that a better surveillance result can be obtained. For example, discharged diagnosis codes and positive bacteria results are combined to identify surgical site infections (SSI), or the three suspected criteria, i.e. positive bacteria reports, antibiotics and discharged diagnosis codes, are combined to perform the retrospective analysis.

Moreover, some nosocomial infection surveillance systems are based on measurement of patients' body temperature. For example, TW I229730 discloses a body temperature measurement and monitoring system focusing on preventing the spread of Severe Acute Respiratory Syndrome (SARS) through the measurement of patients' body temperature. A body temperature sensor and remote monitor device with a wireless transmission module that can receive signals within a certain range are provided so that the monitoring personnel can monitor and record the user's body temperature, time and position. If the user is detected to have a fever, the monitoring personnel at the remote site can take emergency response measurements. Thus, the body temperature can be monitored, and persons who contacted the user and the contact times can be traced. Though SARS infections in the hospitals are also regarded as nosocomial infections, there are many situations such as urinary-tract infections, blood stream infections which can not be detected by only fever reports. If the detection only depends on fever reports, other infections might be overlooked. Furthermore, this detection requires sensors be installed to human bodies, which may cause inconvenience.

Besides, TW 201023831 discloses a prediction system of getting rid of a respirator. The system is suitable for predicting whether a patient under evaluation can get rid of a respirator successfully. The system comprises an interface module, a normalization module, and a supporting vector machine. The interface module provides a user interface. The user interface is used for inputting a set of evaluated parameters of the evaluated patient. The set of evaluated parameters comprises a coma index in hospital, a coma index after the respirator is detached, quick and shallow breathing index after the respirator is detached, the number of days using a respirator, respirator related pneumonia or other infections in the hospital. The normalization module normalizes the set of evaluated parameters and produces a set of normalized parameters. The supporting vector machine classifies the evaluated patient according to the set of normalized parameters, and generates a prediction result indicating if the evaluated patient can get rid of a respirator successfully. This invention is directed to a prediction of a patient getting rid of a respirator to prevent the infection resulting from wearing a respirator inappropriately. However, the invention is used to predict whether a patient can get rid of a respirator successfully, not to detect infections.

There is a need of a high performance and integrated nosocomial infection surveillance method and system which do not focus on the detection of an individual infection matter, do not require special sensors to collect information of patients, and can perform nosocomial infection surveillance through the medical records in the hospitals to achieve efficient surveillance of nosocomial infections.

### SUMMARY OF THE INVENTION

To achieve the foregoing objective, this invention provides a high performance and integrated nosocomial infection surveillance and detection system. The system integrates information related to patients and nosocomial infections, and is capable of providing clinicians or infection controlling personnel with a infection surveillance of all patients by operating the infection monitoring dashboard. This invention can also perform detection of suspected and non-suspected cases to improve investigation procedures and work efficiency.

The invention is related to an integrated nosocomial infection surveillance and detection method through the internet. By integrating the patient information and various clinical information in the hospital, a high performance nosocomial infection control and surveillance can be achieved. The method comprises: (1) providing a patient database (comprising, for example, index column information of hospitalized patients, patient basic information, date of hospitalization, primary care physician (PCP), hospital bed number and related medical information); (2) providing a clinical database (comprising, for example, clinical examination data, records of medication, records of surgery and invasive devices, and records of radiographic images); (3) providing an infection monitoring dashboard integrating the information from the patient database and the clinical database based on the index column information of hospitalized patients into a set of related infection information for individual patient; (4) providing a nosocomial infection surveillance model computing the infection information of the hospitalized patient to identify whether the patient is a suspected case; and (5) allowing a user to access and browse the infection monitoring dashboard so that the user can further determine whether the patient is an infected case through the internet.

As patient information and various clinical information are stored in the internal information systems in the hospital, regardless of which internal system the information is stored in, any of the internal information systems should provide a nosocomial infection data collecting service program and publish it in a network service directory server. The nosocomial infection surveillance and detection system of the present invention is capable of obtaining the data collecting service program through the service directory server. By conducting said service, the nosocomial infection surveillance and detection system of the present invention can collect patient information and various clinical information, and integrate nosocomial infection information of patients.

According to the method stated above, the infection monitoring dashboard provides a quick browsing interface comprising the whole patients sub-area, the suspected patients sub-area, the infected patients sub-area and geographic information of the suspected infection patients according to the hospital wards and beds. The interface can further show detailed medical records for users to browse. The detailed medical records comprise the medication records with respect to oral administration and injection of antibiotic, positive bacteria records, surgery and invasive devices records, white blood cell (WBC) records, leukocyte esterase records, nitrite records, drug-resistant bacteria reports and image reports.

According to the method stated above, the model computing in step (4) can be performed through any analysis methods well known by persons having ordinary skill in the art to identify whether the patient is suspected of having nosocomial infection. For example, a discriminant analysis can be applied in the present invention. Once a new sample (a new patient) is encountered, the discriminant analysis criteria can be used to determine which group (the suspected group or non-suspected group) should the new sample belong to. Therefore, the present invention computes the infection information of the hospitalized patient via the discriminant analysis to identify whether the patient is suspected of having nosocomial infection.

According to the method stated above, the method further comprises an infection information analysis mechanism comprising the following steps: (1) providing an infection knowledge database comprising knowledge factors of infections (comprising, for example, the behavior pattern of antibiotic medication prescribed by doctors for suspected patients, the records with respect to oral administration and injection of antibiotic, reference values of positive bacteria results, codes related to surgery and invasive devices shown as health insurance codes, WBC risk values, leukocyte esterase abnormal values, and nitrite abnormal values; and (2) providing a risk analysis model which is used in combination with the infection controlling knowledge of the infection knowledge database. The model performs risk analysis on the basis of the infection information, and eventually the results are fed back to the infection monitoring dashboard. The risk analysis can be performed through any analysis methods well known by persons having ordinary skill in the art.

The present invention further provides an integrated nosocomial infection surveillance and detection system through the internet. The system integrates the patient information and various clinical information in the hospital. The system comprises a patient database (comprising, for example, index column information of hospitalized patients, patient basic information, date of hospitalization, doctor in charge, hospital bed number and related medical information); a clinical database (comprising, for example, clinical examination data, records of medication, records of surgery and invasive devices, and records of radiographic images); an infection monitoring dashboard integrating the information in the patient database and the clinical database into a set of related infection information for individual patient, and providing a quick browsing interface comprising the whole patient sub-area, the suspected patient sub-area, the infected patient sub-area and the geographic information of the suspected infection patients on the basis of the hospital wards and beds. The interface can further show detailed medical records for users to browse; and an infection surveillance model computing the infection information of the hospitalized patient to identify whether the patient is a suspected nosocomial infection case and feed back the results to the infection monitoring dashboard. The patient database, clinical database, the infection surveillance model and the infection monitoring dashboard can be built in different network servers or in a network server to meet the optimum efficiency for a user to conduct infection control and early detection of infected cases through his/her account.

As patient information and various clinical information are stored in the internal information systems in the hospital, regardless of which internal system the information is stored in, any of the internal information system should provide a nosocomial infection information collecting service program, and publish it in a network service directory server. The nosocomial infection surveillance and detection system of the present invention is capable of obtaining the information collecting service program through the service directory server. By conducting said service, the nosocomial infection surveillance and detection system of the present invention can collect patient information and various clinical information and integrate nosocomial infection information.

The system stated above further comprises an infection knowledge database comprising relevant knowledge with respect to infectious factors including: the behavior pattern of antibiotic medication prescribed by doctors for suspected patients, the records with respect to oral administration and injection of antibiotic, reference values of positive bacteria results, codes related to surgery and invasive devices shown as health insurance codes, WBC risk values, leukocyte esterase abnormal values and nitrite abnormal values; and a risk analysis model which is used in combination with the infection controlling knowledge of the infection knowledge database. The model performs risk analysis on the basis of the infection information, and eventually the results are fed back to the infection monitoring dashboard.

According to the system stated above, the quick browsing interface shows the infection levels of each infection item of patients in different colors.

According to the system stated above, the quick browsing interface shows the detailed medical records of patients for users to browse.

According to the system stated above, the detailed medical records comprise the medication records with respect to oral administration and injection of antibiotic, positive bacteria records, surgery and invasive devices records, white blood cell (WBC) records, leukocyte esterase records, nitrite records, drug-resistant bacteria reports and results of image reports.

According to the system stated above, the patient database, the clinical database, the infection monitoring dashboard, and the infection surveillance model are built in a network server.

### REFERENCES

1. Bouam S, Girou E, Brun-Buisson C, Karadimas H, Lepage E. An internet-based automated system for the surveillance of nosocomial infections: prospective validation compared with physicians' self-reports. Infect Control Hosp Epidemiol 2003; 24:51-5.
2. Brossette S E, Hacek D M, Gavin P J, et al. A laboratory based, hospital-wide, electronic marker for nosocomial infection: the future of infection control surveillance. Am J Clin Pathol 2006; 125:34-9.
3. Chalfine A, Cauet D, Lin W C, et al. Highly sensitive and efficient computer-assisted system for routine surveillance for surgical site infection. Infect Control Hosp Epidemiol 2006; 27:794-801.
4. Spolaore P, Pellizzer G, Fedeli U, et al. Linkage of microbiology reports and hospital discharge diagnoses for surveillance of surgical site infections. J Hosp Infect 2005; 60:317-320.
5. Pokorny L, Rovira A, Martin-Baranera M, Gimeno C, Alonso-Tarres C, Vilarasau J. Automatic detection of patients with nosocomial infection by a computer-based surveillance system: a validation study in a general hospital. Infect Control Hosp Epidemiol 2006; 27:500-503.
6. Leth R A, Moller J K. Surveillance of hospital-acquired infections based on electronic hospital registries. J Hosp Infect 2006; 62:71-79.

### BRIEF DESCRIPTION OF THE DRAWINGS

The structure and the technical means adopted by the present invention to achieve the above and other objectives can be best understood by referring to the following detailed description of the preferred embodiments and the accompanying diagrams.

FIG. 1 is a schematic view showing the operation of the high performance and integrated nosocomial infection surveillance and detection system through the internet according to the present invention.

FIG. 2 is a schematic view showing the high performance and integrated nosocomial infection surveillance and detection system through the internet according to the present invention.

FIG. 3 is a schematic view showing the authorization managing mechanism and the communication with the users according to the present invention.

FIG. 4 is a schematic view exemplifying a high performance and integrated nosocomial infection surveillance and detection system through the internet according to the present invention.

FIG. 5 is a schematic view showing the infection information analysis mechanism according to the present invention.

FIG. 6 is a schematic view showing the infection information analysis mechanism according to the present invention.

FIG. 7 is a schematic view exemplifying a high performance and integrated nosocomial infection surveillance and detection system through the internet according to the present invention.

FIG. 8 is a schematic view showing the information included in the infection monitoring dashboard.

### DETAILED DESCRIPTION OF THE INVENTION

The present invention can be accomplished by several styles and methods, and the illustrations of following words and figures are showing the embodiments of the present invention. Although these figures are not for limiting the scope of the present invention, the amendments and modifications, which can be easily achieved by persons having ordinary skill in the art, are the categories of the present invention.

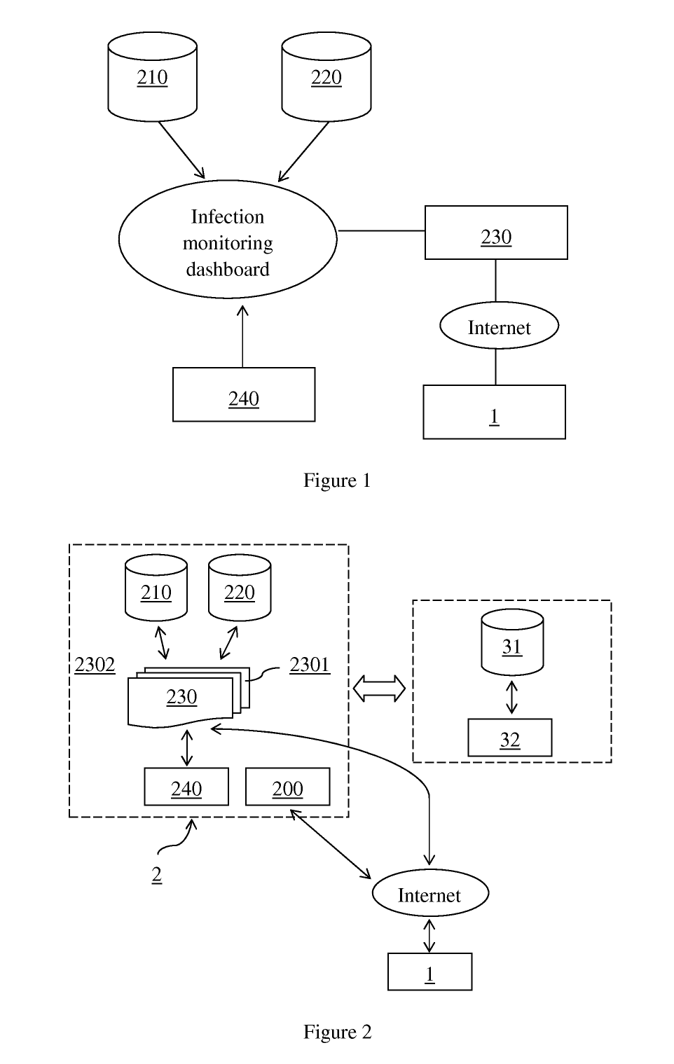

Referring to the FIG. 1, it is the method for operating the high performance and integrated nosocomial infection control surveillance and detection system of the present invention, wherein it discloses the following steps: the step (1) is offering a patient database 210, which comprises relevant basic information of each patient, index column information of hospitalized patients, patient basic information, date of hospitalization, primary care physician (PCP), number of bed, and relevant medical care information, within the hospital. The step (2) is offering a clinical information database 220, which comprises relevant patient clinical information, clinical examination data, medication records of each patient, surgery procedure and invasive device records, and radioactive image reports, within the hospital. The step (3) is offering an infection monitoring dashboard 230, which takes every information from database of patients and clinical information database by index column of patients, and integrates all the patient's relevant infection data of each patient as per unit. The step (4) is offering a nosocomial infection surveillance model 240, which operates the model calculation of the relevant infection data of infection monitoring dashboard 230, and distinguishes that whether the suspected patient is an individual case by nosocomial infection or not. This model is comprising an infection detection algorithm, familiar to persons having ordinary skill in the art. For instances, the discriminant analysis is an analyzing method, applicable in present invention. This method is to build a linear function by utilizing a known classification:

L=c+b₁X₁+b₂X₂+ . . . +bₙXₙ, n is a positive integer.

where n is the discriminant series, c is a constant, b₁ to bₙ are discriminant coefficients, and X₁ to Xₙ are factor variable or predictor variables. First, taking the coefficients of b₁ to bₙ, by partial data calculation is for building the model, and this method can be the analytical standard of determination. Once facing new samples (new patients), the way to determine is to place new samples into the corresponding groups. Therefore, the patients can be distinguished, by analyzing the infection data on the infection monitoring dashboard 230, that whether they are suspected nosocomial infection individual cases or not. The step (5) is accepting that a user 1 to retrieve and browse the infection monitoring dashboard through the internet, and further determine that whether the patients are infection individual cases or not.

FIG. 2 is further disclosing another state of the present invention. As shown in FIG. 2, the present invention can be classified into three parts during operation, one is user 1, second is network server 2, and the third is infection data analyzing mechanism 3.

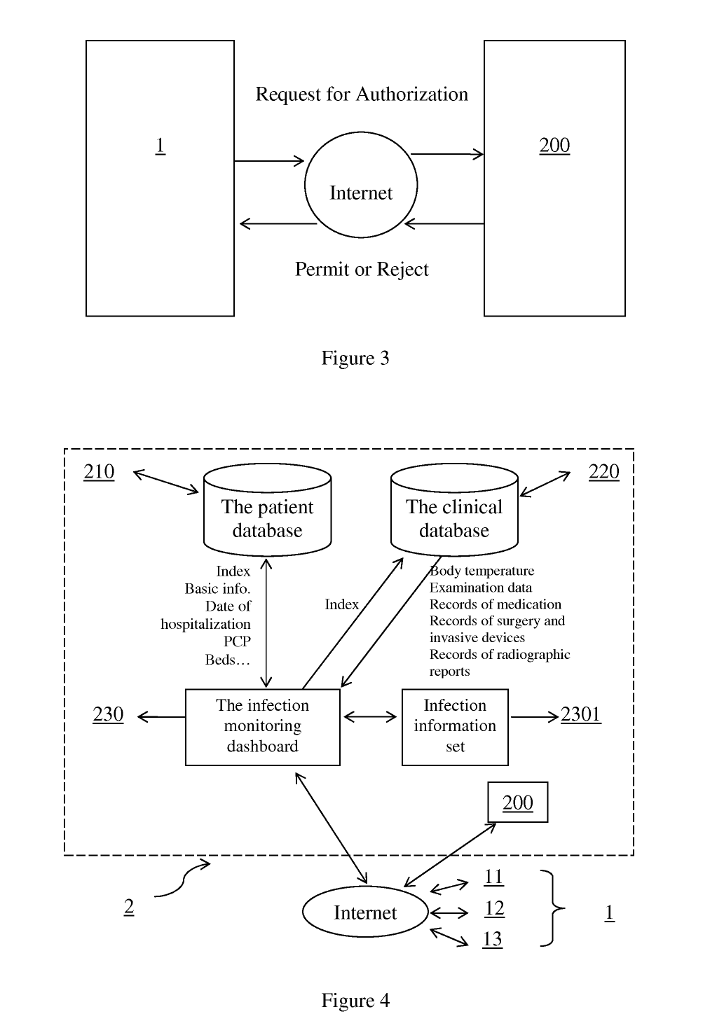

The user 1 can be a doctor 11, an infection controller 12 or a system manager 13 etc. These users can access the network server 2 through the internet and log in the system by the account and authorization managing mechanism 200, details illustrated in FIG. 3. User 1 can acquire the information desired by every user by the account and authorization managing mechanism 200 and infection monitoring dashboard 230.

The network server 2 comprises a patient database 210, a clinical information database 220, an infection monitoring dashboard 230, a nosocomial infection surveillance model 240, and the account and authorization managing mechanism 200. The patient database 210, clinical information database 220, and the infection monitoring dashboard 230 are linked together to search the patient database 210 and the clinical information database 220, based on the index column of the hospitalized patient in the patient database 210, by the infection monitoring dashboard 230, and integrate as the patient's relevant infection dataset 2301 by the unit of each patient.

Furthermore, the patient database 210 comprises the index column of patient and patient basic information, such as name, gender, date, days of staying, primary care physician (PCP), and numbers of bed etc, wherein the index column of the hospitalized patient is for linking to the clinical information database 220, and the rest are for the patient basic information. The clinical information database 220 is comprising the clinical examination data, medication record, record of surgery procedure and invasive device and record of medical image (like radioactive image) report etc. The infection monitoring dashboard 230 is to acquire and integrate every data in the clinical information database 220 by the index column of patient of the patient database 210, and generate the patient's relevant infection dataset 2301 by the unit of per patient. As a result, the patient's relevant infection dataset 2301 comprises the patient database 210 and data record folder of the clinical information database 220, details shown as in FIG. 4.

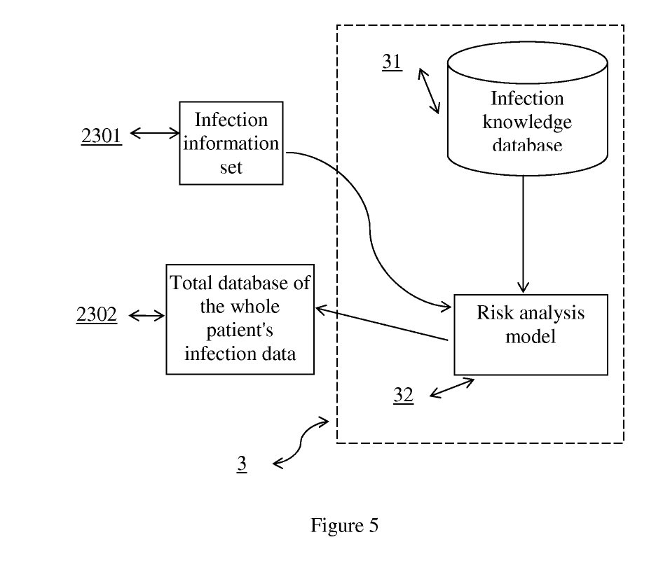

Regarding the infection data analyzing mechanism 3 is mainly analyzing infection data, ranged from fever analysis, medication behavior analysis, examination result analysis, to every patient's invasive procedure and device analysis, of the patient for confirming whether it is risky for every infection datum of the patient. Thus, there is generally an infection knowledge database 31 and a risk analysis model 32 in the infection data analyzing mechanism 3. The knowledge of infection rule is saved in the infection knowledge database 31, which comprises the knowledge of rule, such as fever, antibiotic medication, invasive procedure and device, value of white blood cell (WBC), abnormal value of leukocyte esterase, abnormal value of nitrite, and bacterial species. The risk analyzing model 32 is an analytical logics, combined by relevant infection data of patient and data of 2301, and analyzing, assisted by infection knowledge database 31, every patient automatically and regularly for generating a whole dataset 32, including all patients' infection data, as shown in FIG. 5.

Furthermore, the medical knowledge of antibiotic saved in the infection knowledge database 31 is the data of antibiotic medication, covering from first-line to third-line antibiotics, injectable and oral antibiotics, and the external medication excluded by the antibiotics, wherein the medication is involving from the code, name, scientific name, and line of the antibiotics. The knowledge of invasive procedure and device is comprising the codes of the treatment paid by health insurance defined by codes of the domestic health insurance, and saving by every section of infection, the urinary track infection (UTI) shown in Table 1.

TABLE 1

| section of infection | Name of the items | Codes |
|---|---|---|
| UTI | Cystoscopy | 28019C |
| | Urinal | 47014C \grave{ } 47013C |
| | catheterlization | |
| | Percutaneous | 33095B |
| | Nephrostomy, PCN | |
| | Double J | 50019C |
| | Partially anesthesia | 78001CA |
| | Cystofix | |

The knowledge of the value of white blood cell(WBC) is comprising a normal examination result, including the qualitative and quantitative methods, as shown in Table 2.

TABLE 2

| Type | normal value |
|---|---|
| qualitative | — |
| quantitative | 0~5 |

The knowledge of data of the bacterial species comprises the result of the name of bacteria nurtured by the lab, as shown in Table 3.

TABLE 3
name of the bacteria

Strep. oralis
(Streptococcus spp
E. coli (ESBL)-1
E. coli (ESBL)-2
. . .

The knowledge of fever is an abnormal value of temperature, including the body temperature of human and rectal temperature of baby, as shown in Table 4.

TABLE 4

| | the value of temper- |
|---|---|
| Position measured | ature during the fever |
| Body temperature of human | >38° C. |
| rectal temperature of baby | >38° C. or <37° C. |

The knowledge of the leukocyte esterase and nitrite are an set of abnormal result values, as shown in Table 5.

TABLE 5

| Name of the items | abnormal result |
|---|---|
| leukocyte esterase | Positive or + |
| nitrite | Positive or + |

Furthermore, the risk analysis model 32 is the analytical logic, the knowledge of infection built by infection knowledge database 31. The infection of knowledge, as shown in Tables 1 to 5, is used for analyzing the relevant infection data of the patient and the data of 2301, such as body temperature, examination result and every invasive procedure and device. The process of the analysis is for comparing relevant infection dataset 2301 with knowledge of infection for confirming that whether every infection data of patient is risky or not.

Plus, the medication behavior analysis behavior is operating the risk analysis calculation mainly by the medication record of the patient in the infection dataset 2301, and knowledge of antibiotic medication saved in the infection knowledge database 31 for deducing the description of antibiotics, due to the suspected nosocomial infection, in the medication record made by clinical doctor.

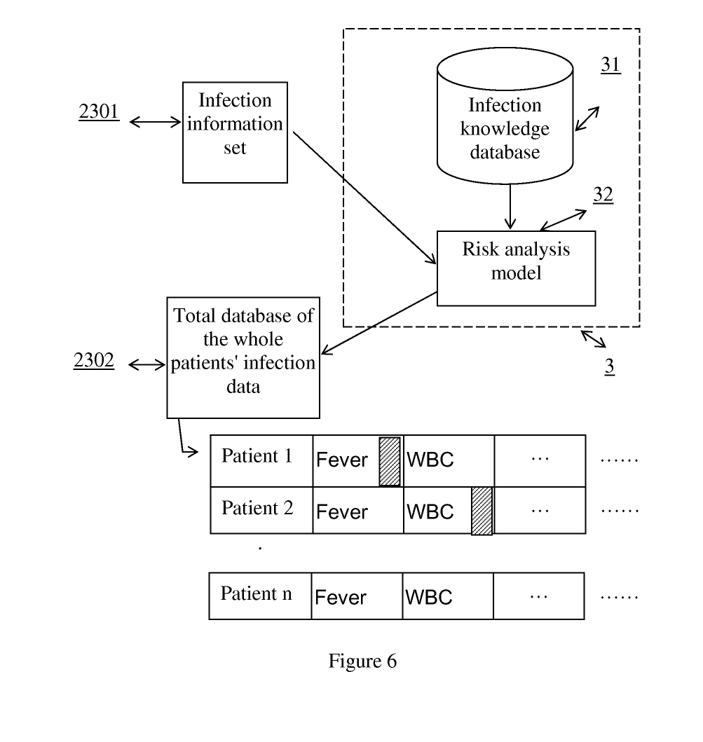

Therefore, the infection data combined with the data of 2301 are eventually generating a total database of the whole patients' infection data 2302 by the operations of the infection knowledge database 31 and risk analysis model 32. The total database of the whole patients' infection data 2302 has marked individual patient having risky infection data, and simultaneously send it back to the infection monitoring dashboard. As shown in FIG. 6, the total database of the whole patients' infection data 2302 has all the records of relevant infection data of patients, and will mark the infection information for labeling the risk of infection after calculating by the risk analysis model.

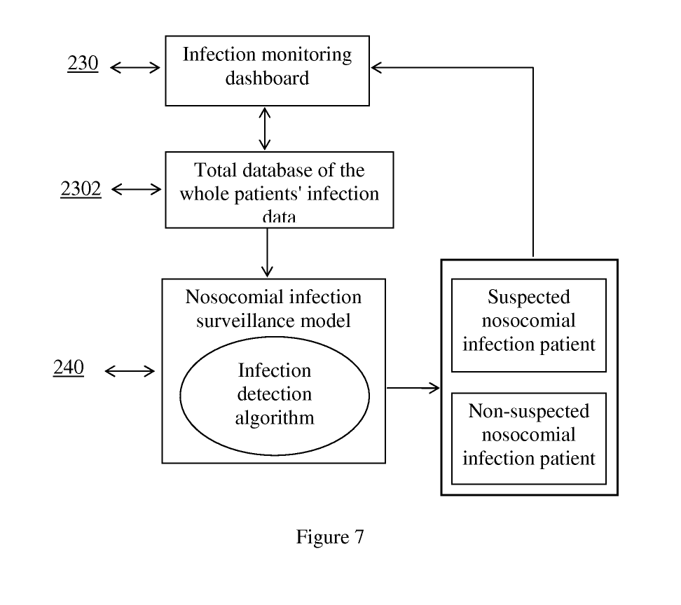

The nosocomial infection surveillance model 240 comprises an infection detection algorithm to do the detection calculation, based on the algorithm, by the total database of the whole patients' infection data 2302 in the infection monitoring dashboard 230 for determining the suspected nosocomial infection patient and non-suspected nosocomial infection patient and feeding back to the infection monitoring dashboard 230. After the infection detection algorithm, as shown in FIG. 7, it will automatically divide all patients in the total database of the whole patients' infection data 2302 into two sub-datasets, suspected nosocomial infection individual cases and non-suspected nosocomial infection individual cases datasets, respectively, and simultaneously feed these two datasets back to the infection monitoring dashboard 230.

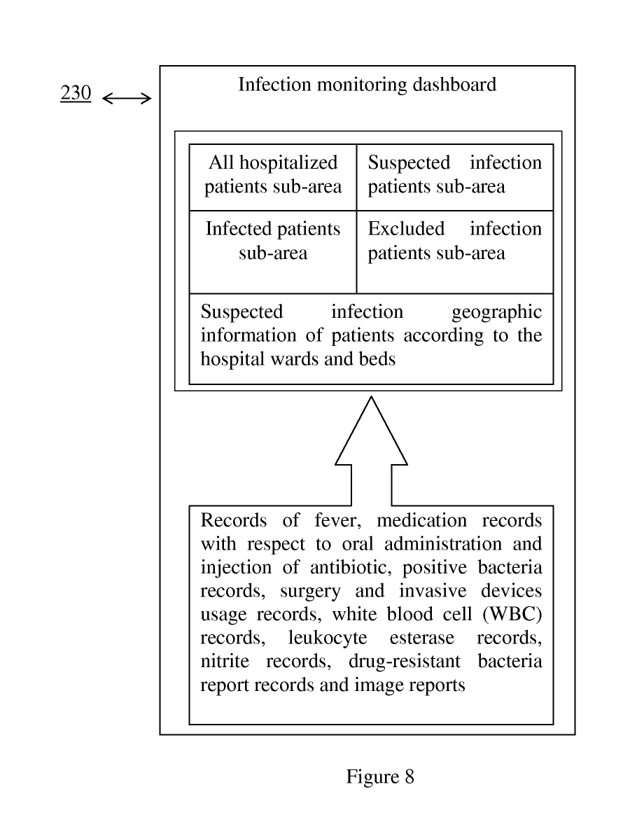

The infection monitoring dashboard 230, as shown in FIG. 8, is mainly for offering user a quick browsing interface, and the interface sub-areas including the all patients of hospitalization sub-area, the suspected patients sub-area, the infected patients sub-area, the excluded infection patients sub-area, and the suspected infection geographic information of patients according to the hospital wards and beds. The whole patients sub-area will show all the infection data of all patients of that day. The suspected patients sub-area will show the result of the suspected individual cases by the infection detection algorithm included by the nosocomial infection detection model 240. The infected patients sub-area will show the infection patients confirmed by clinical doctors or infection controllers. The excluded infection patients sub-area will show the non-infection patients excluded by clinical doctors or infection controllers. And the suspected infection geographic information of patients will show all the infection data of the hospitalized patients on that day. Patients in every sub-area can be further accessed for users to browse the detailed information of patients, for instance, the records of fever, the medication records with respect to oral administration and injection of antibiotics, positive bacteria records, surgery and invasive devices usage records, white blood cell (WBC) records, leukocyte esterase records, nitrite records, drug-resistant bacteria report records, and image reports. If the infection parts of the patients are risky, they are shown as red symbols, as for non-risky infection, they are shown as green symbols.

The high performance and integrated nosocomial infection control surveillance and detection system of the present invention are designed based on the application of the network to integrate the relevant data of patients' nosocomial infection. The relevant nosocomial infection of patients is saved in the private information system of the hospital. Therefore, no matter where the patient clinical information and hospitals are saved, every information system of the hospital is supposed to offer the relevant nosocomial infection data collecting programs, and publish the programs on the network service category servers. The nosocomial infection surveillance and detection system of the present invention can acquire the data collecting programs via the network service category servers, that is tuning this service to collect relevant patient clinical information and the hospitals, and integrating of nosocomial infection information of the patients without being limited by time or location.

The infection monitoring dashboard of the present invention can show the infection information of the hospitalized patients in various type, color, geographic regions, and kinds of data, according to the risky status of infection, location of the hospital beds, and types of patients. To meet the need of the user, it will provide adequate records of patients for conducting the infection surveillance over the whole patients of hospitalization.

The infection detection algorithm of the present invention is used for the model calculation of the relevant infection data of the hospitalized patients shown in the infection monitoring dashboard, and the results of the model calculation are used to determine that whether the patients of hospitalization are suspected nosocomial infection individual cases or not, wherein the sensitive and the difference are all over 99% and 94%.

The risk analysis model of the present invention is used in combination with the infection controlling knowledge of the infection knowledge databases, and perform the risk analysis on the basis of the infection data of patients. Finally, the results of the analysis will be fed back to the infection monitoring dashboard, offering immediate and appropriate information of the relevant nosocomial infection of patients.

The present invention can improve the current nosocomial infection surveillance model, solve the shortage of the human or equipment resources relevant to the nosocomial infection surveillance system of the hospitals, decrease the need of people, solve the issues of the raise of the budget and the danger of the safety of the patient due to the nosocomial infection or group infection of patients, and upgrade the quality of the health care.

The disclosure of the present invention is mean to explain that how to form and use the embodiments of the present invention, but not limiting the actual, indicating, and appropriate categories, and true spirit of the present invention. The above discussions are not mean to be explicit or the defined formations, disclosed and limited by present invention. Base on above illustration, it is possible to be amended or varied. The selective and illustrative embodiments offer the best explanation of the theory and actual applications of present invention, and benefit persons having ordinary skill utilizing the present invention in several embodiments, and any specific variation used as expected. To explain all the amendments and variations, within the claims and corresponding defined categories of the present invention, in view of the fair, legitimate, and reasonable authorized scope, the amendments and variations can be amended during the period before any decisions.

What is claimed is:

1. An integrated nosocomial infection surveillance and detection method through the internet, said method integrating the patient information and various clinical information in the hospital to achieve the high performance nosocomial infection control and surveillance, comprising:
(1) providing a patient database;
(2) providing an clinical database;
(3) providing an infection monitoring dashboard integrating the information from the patient database and the clinical database based on the index column information of hospitalized patients into a set of related infection information for individual patient;
(4) providing a nosocomial infection surveillance model computing the infection information of the hospitalized patient to identify whether the patient is a suspected case; and
(5) allowing a user to access and browse the infection monitoring dashboard so that the user can further determine whether the patient is an infected case through the internet.

2. The method of claim 1, wherein the patient database comprises index column information of hospitalized patients, patient basic information, date of hospitalization, primary care physician, hospital bed number, and related medical information.

3. The method of claim 1, wherein the clinical database comprises clinical examination data, records of medication, records of surgery and invasive devices, and records of radiographic images.

4. The method of claim 1, wherein the infection monitoring dashboard provides a quick browsing interface comprising the whole patients sub-area, the suspected patients sub-area, the infected patients sub-area, and geographic information of the suspected infection patients according to the hospital wards and beds.

5. The method of claim 4, wherein the interface further show detailed medical records for users to browse.

6. The method of claim 5, wherein the detailed medical records comprise the medication records with respect to oral administration and injection of antibiotic, positive bacteria records, surgery and invasive devices records, white blood cell (WBC) records, leukocyte esterase records, nitrite records, drug-resistant bacteria report records and image reports.

7. The method of claim 1, wherein the model computing in step (4) is performed through a discriminant analysis to identify whether the patient is suspected of having nosocomial infections.

8. The method of claim 7, wherein the discriminant analysis builds a linear function:
L=c+b₁X₁+b₂X₂+ . . . +bₙXₙ, n is a positive integer;
where n is the discriminant series, c is a constant, b₁ to bₙ are discriminant coefficients, and X₁ to Xₙ are factor variables or predictor variables.

9. The method of claim 1, further comprising an infection information analysis mechanism to identify if the patient has infection risk in light of the infection information, wherein the mechanism comprises the steps:
(1) providing an infection knowledge database comprising knowledge factors of infections; and
(2) providing a risk analysis model which is used in combination with the infection controlling knowledge of the infection knowledge database to perform risk analysis, and eventually, the results are fed back to the infection monitoring dashboard.

10. The method of claim 9, wherein the knowledge factors of infections comprise the behavior pattern of antibiotic medication prescribed by doctors for suspected patients, the records with respect to oral administration and injection of antibiotic, reference values of positive bacteria results, codes related to surgery and invasive devices shown as health insurance codes, WBC risk values, leukocyte esterase abnormal values, and nitrite abnormal values.

11. An integrated nosocomial infection surveillance and detection system through the internet, said system integrating the patient information and various clinical information in the hospital, comprising:
a patient database;
a clinical database;
an infection monitoring dashboard integrating the information in the patient database and the clinical database into a set of related infection information for individual patient, and providing a quick browsing interface comprising the whole patients sub-area, the suspected patients sub-area, the infected patients sub-area, and the geographic information of the suspected infection patients on the basis of the hospital wards and beds; and
a nosocomial infection surveillance model for computing the infection information of the hospitalized patients to identify whether the patient is a suspected nosocomial infection case and feed back the results to the infection monitoring dashboard;
wherein the patient database, the clinical database, the infection surveillance model and the infection monitoring dashboard are built in a network server or in different network servers to meet the optimum efficiency for a user to conduct infection control and early detection of infected cases through his/her account.

12. The system of claim 11, wherein the patient database comprises index column information of hospitalized patients, patient basic information, date of hospitalization, primary care physician, hospital bed number, and related medical information.

13. The system of claim 11, wherein the clinical database comprises clinical examination data, records of medication, records of surgery and invasive devices, and records of radiographic images.

14. The system of claim 11, wherein the nosocomial infection surveillance model comprising a discriminant analysis algorithm.

15. The system of claim 14, wherein the discriminant analysis builds a linear function:
L=c+b₁X₁+b₂X₂+ . . . +bₙXₙ, n is a positive integer;
where n is the discriminant series, c is a constant, b₁ to bₙ are discriminant coefficients, and X′ to Xₙ are factor variables or predictor variables.

16. The system of claim 11, further comprising:
an infection knowledge database comprising knowledge factors of infections; and
a risk analysis model which is used in combination with the infection controlling knowledge of the infection knowledge database to perform risk analysis and eventually to feed back the results to the infection monitoring dashboard.

17. The system of claim 16, wherein the knowledge factors of infections comprise the behavior pattern of antibiotic medication prescribed by doctors for suspected patients, the records with respect to oral administration and injection of antibiotic, reference values of positive bacteria results, codes related to surgery and invasive devices shown as health insurance codes, WBC risk values, leukocyte esterase abnormal values, and nitrite abnormal values.

18. The system of claim 16, wherein the quick browsing interface shows the infection level of each infection item of patients in different colors.

19. The system of claim 11, wherein the quick browsing interface shows the detailed medical records of patients for users to browse.

20. The system of claim 19, wherein the detailed medical records comprise the medication records with respect to oral administration and injection of antibiotic, positive bacteria records, surgery and invasive devices records, WBC records, leukocyte esterase records, nitrite records, drug-resistant bacteria reports and image reports.
